(19) United States
(12) Patent Application Publication
(10) Pub. No.: US 2012/0059118 A1
(43) Pub. Date: Mar. 8, 2012

(54) TWO-PACK POLYURETHANE PAINT FOR BACKING FILMS

(75) Inventors: Andreas Klein, Leverkusen (DE); Joachim Petzoldt, Monheim (DE); Nusret Yuva, Burscheid (DE); Christoph Irle, Shanghai (CN)

(73) Assignee: BAYER MATERIALSCIENCE AG, Leverkusen (DE)

(21) Appl. No.: 13/147,477

(22) PCT Filed: Feb. 5, 2010
(86) PCT No.: PCT/EP10/00957

§ 371 Date: Sep. 1, 2011

(30) Foreign Application Priority Data
Feb. 10, 2009 (EP) 09001801.1

(51) Int. Cl. C09D 175/06

(52) U.S. Cl. 524/591

(57) ABSTRACT

The invention relates to a two-pack polyurethane paint for a backing film, a method for the production thereof and use thereof for application to moulded plastic parts.

The invention relates to a two-component polyurethane lacquer for a backing film, to a process for production thereof, and to the use thereof for the purpose of finishing plastic mouldings.

The surface of many thermoplastic synthetic materials is relatively sensitive with regard to its mechanical and chemical resistance. Direct colouring by dyeing of the substrate is also limited with respect to the colour tones and effects to be achieved. Moreover, visible surface defects, for example flow lines, may arise in the course of injection moulding which are unacceptable for applications in the visual field.

Foamed components frequently exhibit, in addition, surface defects and/or pores that make flawless lacquering very difficult. Especially after possible grinding operations, the affected parts have to be smoothed over manually prior to lacquering.

The lacquering of plastic mouldings for the purpose of obtaining the requisite resistance properties and the desired appearance is generally known. In the field of high-quality plastic parts with corresponding requirements in terms of mechanical characteristics, resistance and longevity, lacquers based on polyurethane predominate which constitute a compromise between mechanical characteristics adapted to the flexible substrates and the requisite resistance properties.

Composite elements consisting of lacquer layer and plastic component are produced, as a rule, by subsequent lacquering, in a spray process or immersion process, of the component that was previously foamed or produced by injection moulding. Particularly in automobile construction, this is the preferred procedure for producing large-area components or those with complex geometry. This subsequent application of the lacquer layer requires a large number of separate working steps, which, in part, have to be performed manually and cannot be automated. Moreover, certain constituent areas of the component can only be coated with great effort. Furthermore, in the course of the lacquering of three-dimensional bodies a not inconsiderable material loss of the lacquer, so-called overspray, has to be reckoned with. Moreover, the frequency of errors in the course of the lacquering of three-dimensional parts is distinctly higher than in the course of the technically simpler coating of two-dimensional films.

In order to arrive at an efficient, inexpensive procedure that saves raw material, processes are known in which plastic films are firstly coated over a large area by means of common lacquering processes such as knife coating, rolling or spray coating, and this coating dries in virtually tack-free manner by physical drying or partial curing. These films can then be deformed at elevated temperatures and subsequently adhesion-bonded, rear-injected or foam-backed. This concept offers great potential for the production of, for example, components by plastics processors, whereby the more elaborate step of the lacquering of three-dimensional components can be replaced by the simpler coating of a flat substrate.

EP-A 1 647 399 describes composite mouldings consisting of a backing film and soft-touch lacquer applied on this film. This backing film serves for rear injection or rear compression moulding with thermoplastics, without the layer of soft-touch lacquer being damaged thereby. For example, no flashes and no cracks appear in the lacquer layer. The polyol component contained in the lacquer formulation also contains, in addition to constructional units that react chemically with the polyisocyanate cross-linker, elasticising, hydroxyl-group-free and/or amine-group-free polyurethanes. These dry exclusively physically and do not cross-link on the substrate by virtue of a chemical reaction. Therefore such coatings do not attain the high level of scratch resistance and resistance to chemicals of chemically fully reacting lacquers.

As a general rule, good surface properties presuppose a high cross-linking density of the coating. A disadvantageous aspect of high cross-linking densities, however, is that these result in thermosetting behaviour with maximally possible degrees of stretching amounting to only a few percent, so that the coating has a tendency to crack during the deforming procedure.

Moreover, for an economical application of this process the interim winding of the coated, deformable film onto rollers is necessary. The compressive stresses and thermal stresses arising thereby in the rollers make particular demands of the blocking resistance of the coating. ‘Blocking resistance’ in this connection signifies the sticky effect that arises in the course of the joining-together of two coated surfaces under stresses such as heat or compression. This obvious conflict between requisite high cross-linking density and high degree of stretching that is striven for can be solved, for example, by the drying/curing of the coating being carried out in two steps, before and after the deformation. Particularly suitable for a post-curing is a radiation-induced cross-linking reaction in the coating.

In WO-A 2005/099943 a flexible laminar composite is described with a backing and with at least one layer, applied onto the backing, of a curable lacquer, the lacquer containing a double-bond-bearing binding agent with a glass transition temperature Tg between −15° C. and 20° C., which after thermal drying is not tacky. In WO-A 2005/099943 it is further described that by reason of the low Tg the coating may be susceptible to dust. In the example a degree of drying or a blocking resistance of the coating prior to radiation curing is obtained at which after a loading of 500 g/cm² for 60 s at 10° C. impressions of a filter paper are still visible. The loadings on a coating in a roll of film relating to pressure and temperature are ordinarily higher. The possibility of winding the films onto rollers prior to radiation curing of the lacquer is therefore also not described in this document.

A disadvantage of this process is, moreover, the necessity of a radiation treatment of the three-dimensional finished parts in order to achieve the desired resistance properties. The curing of the lacquer in so-called shadow regions of the component is therefore not always reliably guaranteed.

The object of the present invention consequently consisted in the provision of a novel aqueous polyurethane lacquer for coating a backing film, said lacquer exhibiting a high level of scratch resistance and resistance to chemicals with, at the same time, high degrees of stretching. Moreover, the coated backing film should be capable of being wound onto rollers without the coating thereby displaying cracks. In this connection a high blocking resistance should likewise obtain, i.e. the backing film should be capable of being unwound from the roller in problem-free manner without sticking.

It has now been found that special aqueous polyurethane lacquers by way of coating on thermoplastic backing films achieve this object.

The present invention consequently provides an aqueous two-component polyurethane lacquer containing
A) at least one hydroxy-functional polyester-polyurethane dispersion containing as structural components
   a1) linear or branched, hydroxy-functional polyesters,
   a2) linear, hydroxy-functional polycarbonates,
   a3) at least one ionic or potentially ionic compound with at least one acid group and with at least one group that is reactive towards isocyanate groups,
   a4) at least one (cyclo)aliphatic diisocyanate and also
   a5) low-molecular hydroxy-functional and/or amino-functional compounds, and also
B) at least one polyisocyanate cross-linker, characterised in that
   the cross-linking ratio of isocyanate groups from B) to hydroxy groups from A) is between 1.0:1 and 1.6:1. The cross-linking ratio preferably amounts to 1.2:1 to 1.4:1.

The two-component polyurethane lacquer may optionally contain further auxiliary substances and additives C).

The mean functionality of the polyisocyanates B) amounts to 2.5 to 3.3, preferably 2.8 to 3.0.

Production of the polyester-polyurethane dispersion A) is effected by polyaddition of components a1) to a5) and subsequent neutralisation of the carboxylic acid and dispersion in water.

In the case of components a5) it is preferably a question of low-molecular compounds with a molar weight Mn from 62 g/mol to 400 g/mol that in total are provided with two or more, preferably three, hydroxyl groups and/or amino groups.

Preferred polyester-polyurethane dispersions A) contain 20 wt. % to 50 wt. %, preferably 30 wt. % to 40 wt. %, component a1), 20 wt. % to 50 wt. %, preferably 30 wt. % to 40 wt. %, component a2), 2 wt. % to 6 wt. %, preferably 3 wt. % to 5 wt. %, component a3), 10 wt. % to 30 wt. %, preferably 15 wt. % to 25 wt. %, component a4), 0.5 wt. % to 10 wt. %, preferably 2 wt. % to 5 wt. %, component a5), whereby the percentage figures a1) to a5) make up 100 wt. %.

The acid groups incorporated via component a3) for the purpose of stabilising the dispersion are present as salt groups in a proportion amounting to 40% to 120%, preferably 50% to 80%.

The acid values, incorporated via component a3), of the hydroxy-functional polyester-polyurethane dispersions according to the invention amount to 5.0 mg to 14.5 mg KOH/g substance, preferably 8.0 mg to 11 mg KOH/g substance, in each instance relative to the aqueous dispersion of the polyester polyurethane.

The mean molecular weight M_{w} of the polyester-polyurethane dispersion A), determinable, for example, by gel permeation chromatography with polystyrene as standard, amounts to 3000 g/mol to 30,000 g/mol, preferably 5000 g/mol to 15,000 g/mol, particularly preferably 6000 g/mol to 10,000 g/mol, and hence is significantly lower than, for example, in the case of polyurethane dispersions according to the state of the art.

The polyesters a1) contained in the polyester-polyurethane dispersion A) can be produced by processes known as such, with elimination of water at temperatures from 100° C. to 260° C., optionally with concomitant use of conventional esterification catalysts, preferentially in accordance with the principle of a melt condensation or azeotropic condensation. Preferred production process for the polyesters a1) is a melt condensation in a vacuum or by using an inert gas.

In this connection, mixtures of various polyesters and also mixtures of polyesters with varying functionalities may also be employed, the average functionality of the polyesters a1) being between 1.8 and 2.5, preferably between 1.9 and 2.1, and particularly preferably amounting to 2.0.

The polyesters a1) have theoretical molecular weights, ascertained by calculation, from 500 g/mol to 3000 g/mol, preferably from 500 g/mol to 1000 g/mol.

The theoretical molecular weight of the polyesters is determined by the following formula: mass of charge [g]/(mol COOH+mol OH)— gram-equivalent COOH.

Preferably employed polyesters a1) are reaction products of
a1ᵢ) 30 wt. % to 77 wt. %, preferably 40 wt. % to 60 wt. %, of at least one at least difunctional carboxylic acid or anhydride thereof,
a1ᵢᵢ) 23 wt. % to 70 wt. %, preferably 40 wt. %-60 wt. %, of at least one diol,
a1ᵢᵢᵢ) 0 wt. % to 10 wt. % of at least one alcohol with more than 2 hydroxyl groups,
a1ᵢᵥ) 0 wt. % to 10 wt. % of other hydroxy-functional and/or carboxy-functional components and/or caprolactone.

Suitable polyester raw materials a1ᵢ) are, for example, phthalic acid anhydride, isophthalic acid, terephthalic acid, adipic acid, sebacic acid, suberic acid, succinic acid, maleic acid anhydride, fumaric acid, dimer fatty acids, tetrahydrophthalic acid anhydride, hexahydrophthalic acid anhydride, cyclohexanedicarboxylic acid and/or trimellitic acid anhydrides or mixtures thereof.

Preferred components a1ᵢᵢ) are adipic acid, phthalic acid anhydride, tetrahydrophthalic acid anhydride, isophthalic acid or glutaric acid; particularly preferred are adipic acid and hexahydrophthalic acid or phthalic acid and also the anhydrides thereof.

Suitable polyester raw materials a1ᵢᵢ) are, for example, 1,2-ethylene glycol, diethylene glycol, triethylene glycol, tetraethylene glycol, 1,2-propylene glycol, dipropylene glycol, tripropylene glycol, 1,3-propanediol, 1,3-butanediol, 1,4-butanediol, 1,6-hexanediol, neopentyl glycol, 1,4-cyclohexanedimethanol, 1,4-cyclohexanediol, butenediol, butinediol, hydrated bisphenols, trimethylpentanediol, 1,8-octanediol and/or tricyclodecanedimethanol and also mixtures thereof.

Preferred components a1ᵢᵢ) are 1,4-butanediol, neopentyl glycol, 1,2-propylene glycol, ethylene glycol, diethylene glycol or 1,6-hexanediol.

Preferred components a1ᵢᵢ) are neopentyl glycol, butanediol and hexanediol.

Suitable polyester raw materials a1ᵢᵢᵢ) are, for example, trimethylolpropane, ethoxylated trimethylolpropane, propoxylated trimethylolpropane, propoxylated glycerin, ethoxylated glycerin, glycerin, pentaerythritol, castor oil and also mixtures thereof.

Preferred component a1ᵢᵢᵢ) is trimethylolpropane.

Suitable polyester raw materials a1ᵢᵥ to be optionally employed are, for example, C₈-C₂₂ fatty acids such as, for example, 2-ethylhexanoic acid, stearic acid, hydrated fatty acids, benzoic acid, monofunctional alcohols such as butyl glycol, butyl diglycol, cyclohexanol, other monofunctional alcohols such as, for example, polyethylene oxides, polypropylene oxides, polyethylene/propylene-oxide mixed copolymers or block copolymers and also mixtures thereof.

In the case of structural component a2) it is a question of linear, hydroxy-functional polycarbonates. Suitable polycarbonates a2) are those which are obtainable, for example, by reaction of carbonic-acid derivatives, for example diphenyl carbonate, dimethyl carbonate or phosgene, with polyols, preferably diols. By way of diols of such a type, ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethylpentanediol-1,3, dipropylene glycol, polypropylene glycols, dibutylene glycol, polybutylene glycols, bisphenol A, tetrabromobisphenol A, but also lactone-modified diols, enter into consideration, for example. The diol component preferably contains 40 wt. % to 100 wt. % hexanediol, preferably 1,6-hexanediol and/or hexanediol derivatives, preferably those which in addition to terminal OH groups exhibit ether groups or ester groups, for example products that were obtained by conversion of 1 mol hexanediol with at least 1 mol, preferably 1 mol to 2 mol, caprolactone or by etherification of hexanediol with itself to form dihexylene glycol or trihexylene glycol. Polyether polycarbonate diols can also be employed. The hydroxyl polycarbonates should be substantially linear. They may, however, optionally be slightly branched through the incorporation of polyfunctional components, in particular low-molecular polyols. Suitable for this purpose are, for example, glycerin, trimethylolpropane, hexanetriol-1,2,6, butanetriol-1,2,4, trimethylolpropane, pentaerythritol, quinitol, mannitol, sorbitol, methyl glycoside or 1,3,4,6-dianhydrohexite. Production of the polycarbonate polyols is preferably effected by the production process described in EP-A 1 404 740 (pp 6-8, Examples 1-6) and EP-A 1 477 508 (p 5, Example 3).

Particularly preferred polycarbonate polyols a2) are those which contain at least 25 wt. % 1,4-butanediol as structural component and exhibit a mean hydroxyl functionality from 1.6 to 4, preferably 1.8 to 3 and particularly preferably 1.9 to 2.3, and a number-average molecular weight from 240 g/mol to 8000 g/mol, preferably from 500 g/mol to 3000 g/mol, particularly preferably from 750 g/mol to 2500 g/mol. The diol component preferably contains 45 wt. % to 100 wt. % 1,4-butanediol and 1 wt. % to 55 wt. % 1,6-hexanediol, particularly preferably 60 wt. % to 100 wt. % 1,4-butanediol and 1 wt. % to 40 wt. % 1,6-hexanediol.

The hydroxyl polycarbonates are preferably linear but may optionally be branched through the incorporation of polyfunctional components, in particular low-molecular polyols. Particularly preferred components a2) are based on mixtures of 1,4-butanediol and 1,6-hexanediol and have a mean hydroxyl functionality from 1.9 to 2.05.

Component a3) contains at least one ionic or potentially ionic compound with at least one acid group and with at least one group that is reactive towards isocyanate groups. Suitable acid groups are, for example, carboxyl and sulfonic-acid groups. Suitable groups that are reactive towards isocyanate groups are, for example, hydroxyl and/or amino groups.

In the case of component a3) it is preferably a question of carboxylic acid exhibiting at least one hydroxyl group, preferably one or two hydroxyl groups. Particularly preferably, by way of component a3) use is made of dimethylolpropionic acid, dimethylolbutyric acid and/or hydroxypivalic acid; quite particularly preferably, use is made of dimethylolpropionic acid.

Likewise suitable acids are, for example, other 2,2-bis(hydroxymethyl)alkanecarboxylic acids such as, for example, dimethylolacetic acid or 2,2-dimethylolpentanoic acid, dihydroxysuccinic acid, Michael addition products of acrylic acid onto amines such as, for example, isophoronediamine or hexamethylenediamine, or mixtures of acids of such a type and/or dimethylolpropionic acid and/or hydroxypivalic acid. Likewise possible is the use of sulfonic acid diols, optionally exhibiting ether groups, of the type described in U.S. Pat. No. 4,108,814. or also of 2-aminoethylaminoethanesulfonic acid.

The free acid groups constitute “potentially ionic” groups, whereas in the case of the salt-like groups obtained by neutralisation with neutralising agents, carboxylate groups or sulfonate groups, it is a question of “ionic” groups.

Suitable polyisocyanates of component a4) are the aromatic, araliphatic, aliphatic or cycloaliphatic polyisocyanates known as such to a person skilled in the art, with an NCO functionality of preferably >2, which may also exhibit iminooxadiazinedione, isocyanurate, uretdione, urethane, allophanate, biuret, urea, oxadiazinetrione, oxazolidinone, acyl urea and/or carbodiimide structures. These can be employed individually or in arbitrary mixtures with one another.

Examples of suitable polyisocyanates a4) are butylene diisocyanate, hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or mixtures thereof with arbitrary isomer content, isocyanatomethyl-1,8-octane diisocyanate, 1,4-cyclohexylene diisocyanate, 1,4-phenylene diisocyanate, 2,4- and/or 2,6-toluoylene diisocyanate, 1,3- and 1,4-bis(2-isocyanatoprop-2-yl)benzene (TMXDI), 1,3-bis(isocyanatomethyl)benzene (XDI), 1,5-naphthylene diisocyanate, 2,4′- or 4,4′-diphenylmethane diisocyanate, triphenylmethane-4,4′,4″-triisocyanate or derivatives based on the aforementioned diisocyanates with uretdione, isocyanurate, urethane, allophanate, biuret, iminooxadiazinedione and/or oxadiazinetrione structure with more than 2 NCO groups.

As an example of a non-modified polyisocyanate with more than 2 NCO groups per molecule, mention may be made of 4-isocyanatomethyl-1,8-octane diisocyanate (nonane triisocyanate), for example.

It is preferably a question of polyisocyanates or polyisocyanate mixtures of the aforementioned type with exclusively aliphatically and/or cycloaliphatically bonded isocyanate groups. Particularly preferred are hexamethylene diisocyanate, isophorone diisocyanate, the isomeric bis(4,4′-isocyanatocyclohexyl)methanes and also mixtures thereof.

The process for producing the aqueous polyester-polyurethane dispersion can be carried out in one or more stages in homogeneous phase or, in the case of multi-stage conversion, partly in disperse phase. After polyaddition, implemented completely or partly, from a1) to a4), a dispersing, emulsifying or dissolving step takes place. Directly afterwards, a further polyaddition or modification in disperse phase optionally takes place.

For the purpose of producing the aqueous polyester-polyurethane dispersions, use may be made of all processes known from the state of the art, such as, for example, prepolymer mixing processes, acetone processes or melt-dispersing processes.

Suitable neutralising agents, which may already be present in the course of conversion of components a1) to a4), are, for example, triethylamine, N-methylmorpholine, dimethylisopropylamine, ethyldiisopropylamine, dimethylcyclohexylamine, triethanolamine, dimethylethanolamine, ammonia, potassium hydroxide and/or sodium hydroxide.

The hydroxy-functional polyester-polyurethane dispersions A) contain, as a rule, 0 wt. % to 10 wt. %, preferably 0 wt. % to 3 wt. %, organic solvents.

The optionally implemented distillative removal of excess quantities of solvent may, for example, be effected under reduced pressure at, for example, 20° C. to 80° C. during or after the dispersing in/with distilled water.

The solids content of the polyester-polyurethane dispersion A) amounts to 40 wt. % to 60 wt. %, preferably 50 wt. % to 57 wt. %.

The dispersions A) exhibit particle diameters—determined, for example, by LCS measurements—from 80 nm to 500 nm, preferably from 100 nm to 200 nm.

The hydroxy-functional polyester dispersions A) exhibiting urethane groups are combined in combination with optionally hydrophilised polyisocyanates B) with free isocyanate groups to form the aqueous two-component coating agents according to the invention. In this use, the coating agent has a limited pot life of up to 24 hours. The coatings produced therefrom are curable at room temperature up to 120° C.

As component B), polyisocyanates with free isocyanate groups are employed. Suitable are polyisocyanates, for example on the basis of isophorone diisocyanate, hexamethylene diisocyanate, 1,4-diisocyanatocyclohexane, bis(4-isocyanatocyclohexane)methane or 1,3-diisocyanatobenzene or on the basis of lacquer polyisocyanates such as polyisocyanates exhibiting allophanate, uretdione, biuret or isocyanurate groups of 1,6-diisocyanatohexane, isophorone diisocyanate or bis(4-isocyanatocyclohexane)methane or lacquer polyisocyanates exhibiting urethane groups, on the basis of 2,4- and/or 2,6-diisocyanatotoluene or isophorone diisocyanate, on the one hand, and low-molecular polyhydroxyl compounds such as trimethylolpropane, the isomeric propanediols or butanediols or arbitrary mixtures of polyhydroxyl compounds of such a type, on the other hand.

Preferred as components B) are low-viscosity, hydrophobic or hydrophilised polyisocyanates with free isocyanate groups on the basis of aliphatic, cycloaliphatic, araliphatic and/or aromatic isocyanates; particularly preferred are aliphatic or cycloaliphatic isocyanates. These polyisocyanates generally exhibit a viscosity from 10 mPas to 3500 mPas at 23° C. If required, the polyisocyanates may find application blended with small quantities of inert solvents, in order to lower the viscosity to a value within the stated range. Triisocyanatononane can also be employed, on its own or in mixtures, as cross-linker component. Water-soluble or dispersible polyisocyanates are obtainable, for example, by modification with carboxylate, sulfonate and/or polyethylene-oxide groups and/or polyethylene-oxide/polypropylene-oxide groups.

For the purpose of hydrophilising the polyisocyanates B) it is preferred to convert the polyisocyanates with deficient quantities of monohydric, hydrophilic polyether alcohols. The production of hydrophilised polyisocyanates of such a type is described, for example, in EP-A 0 540 985. Likewise also preferred are the polyisocyanates described in EP-A 0 959 087, containing allophanate groups, which are produced by conversion of low-monomer polyisocyanates with polyethylene oxide polyether alcohols under allophanatisation conditions. The water-dispersible polyisocyanate mixtures, described in DE-A 100 07 821, on the basis of triisocyanatononane are also suitable, and also polyisocyanates hydrophilised with ionic groups (sulfonate groups, phosphonate groups), such as are described, for example, in DE-A 100 24 624. Similarly possible is the hydrophilisation by addition of commercial emulsifiers.

Particularly preferably, such mixtures are employed as component B) which contain flexibilised polyisocyanate components B) that are readily obtained by prepolymerisation of the aforementioned polyisocyanate components with preferably difunctional to trifunctional polyol components, particularly preferably polyol components such as were already named under structural components a1).

By way of further preferred curing-agent component in this connection, polyisocyanates modified with sulfonate groups, such as are described in DE-A 100 24 624 for example, find application.

Of course, it is also possible to employ component B) in the form of so-called blocked polyisocyanates. The blocking of the aforementioned polyisocyanates with free isocyanate groups is effected in accordance with the known state of the art by conversion of the polyisocyanates with free isocyanate groups with suitable blocking agents. Suitable blocking agents for these polyisocyanates are, for example, monohydric alcohols such as methanol, ethanol, butanol, hexanol, cyclohexanol, benzyl alcohol, oximes such as acetoxime, methyl ethyl ketoxime, cyclohexanone oxime, lactams such as ε-caprolactam, phenols, amines such as diisopropylamine or dibutylamine, dimethylpyrazole or triazole and also malonic acid dimethyl ester, malonic acid diethyl ester or malonic acid dibutyl ester.

If the dispersions A) are applied on their own onto substrates, preferably films, clear, very well-flowing layers without blemishes or craters are obtained, and very high layer thicknesses up to over 100 μm are possible. The dispersions A) display no pronounced physical drying—that is to say, the layers remain more or less tacky or granular. Cured, tack-free and hard layers are obtained only by combination with at least one cross-linker polyisocyanate B) and after curing has taken place.

The aqueous two-component polyurethane lacquer according to the invention applied as coating on the backing films may optionally contain, in addition to components A) and B), the conventional auxiliary substances and additives C) such as organic and/or inorganic pigments or metallic pigments on the basis of aluminium flakes, fillers such as, for example, carbon black, silica, talc, kaolin, glass as powder or in the form of fibres and mixtures of these and/or other materials that are customary for the production of lacquers, coatings and adhesives.

For the purpose of achieving special effects it is also possible to add small quantities of auxiliary substances that are conventional in the lacquer and adhesive industry in the course of the production of the polyester dispersion A), such as, for example, surface-active substances, emulsifiers, stabilisers, anti-settling agents, UV stabilisers, catalysts for the cross-linking reaction, defoamers, anti-oxidants, anti-skinning agents, flow-control agents, thickeners and/or bactericides.

In a preferred embodiment, the aqueous two-component polyurethane lacquer according to the invention contains a silicone additive containing hydroxyl groups, with which a particularly smooth surface is obtained.

The two-component polyurethane lacquer according to the invention is fundamentally suitable for coating, lacquering, adhesion-bonding, treating and sealing the most diverse substrates, in particular metals, wood, ceramic, stone, concrete, bitumen, hard fibre, glass, porcelain, plastics, leather and/or textiles of the most diverse types. A preferred application is the coating of plastic. Particularly preferred is the coating of polycarbonate.

The aqueous two-component polyurethane lacquers according to the invention can be applied onto the substrate to be coated by methods known as such, such as spraying, flow coating, casting, dipping, rolling, brushing.

The aqueous two-component polyurethane lacquers may also be used as part of a multi-layer lacquer structure, consisting, for example, of primer coat and/or filler and/or base-coat lacquer and/or top-coat lacquer. In this connection, wet-on-wet lacquering processes are also possible in which at least two layers are applied in succession, are optionally predried and then jointly stoved. The lacquers may proportionately also contain one or more other aqueous dispersions, for example based on polyester, based on polyurethane, based on polyurethane polyacrylate, based on polyacrylate, based on polyether, based on polyester polyacrylate, based on alkyd resin, based on polymerisate, based on polyamide/imide or based on polyepoxide.

The aqueous two-component polyurethane lacquers according to the invention that are employed as coating for the purpose of producing the backing film are distinguished by very good processability. The resulting coatings exhibit excellent film optics and flow, very slight susceptibility to craters, good resistance properties, a balanced hardness/elasticity level and very good stability in storage. The backing films display, moreover, an excellent blocking resistance, i.e. after being rolled up the backing films can be unrolled from the roller without difficulty.

In order to coat constituent regions on the film, screen printing, for example, is preferably employed. The layer thicknesses may be between 2 micrometres and 100 micrometres, preferably between 5 μm and 75 μm, particularly preferably between 5 μm and 50 μm.

For the production of the backing films, conventional plastic films, for example consisting of PET, polycarbonate, PMMA, polysulfone etc, can be employed as backing film. The films can optionally be pretreated by processes such as corona treatment etc. The backing films preferably exhibit thicknesses between 2 micrometres and 2000 micrometres. Use is preferably made of backing films consisting of polycarbonate and polycarbonate blends. In the case of the backing films it may also be a question of so-called composite films consisting of several plastic layers.

As suitable backing film, in principle all polycarbonates that are known as such or commercially available are suitable. The polycarbonates that are suitable as backing film preferably have a molecular weight within the range from 10,000 g/mol to 60,000 g/mol. They are obtainable, for example, in accordance with the process of DE-B-1 300 266 by interfacial polycondensation or in accordance with the process of DE-A-1 495 730 by conversion of diphenyl carbonate with bisphenols. Preferred bisphenol is 2,2-di(4-hydroxyphenyl)propane, generally designated—as also in the following—as bisphenol A.

Instead of bisphenol A, use may also be made of other aromatic dihydroxy compounds, in particular 2,2-di(4-hydroxyphenyl)pentane, 1,6-dihydroxynaphthalene, 4,4′-dihydroxydiphenylsulfane, 4,4′-dihydroxydiphenyl ether, 4,4′-dihydroxydiphenylsulfone, 4,4′-dihydroxydiphenylmethane, 1,1-di(4-hydroxyphenyl)ethane, 4,4′-dihydroxydiphenylcycloalkanes or dihydroxydiphenylcycloalkanes, preferably dihydroxydiphenylcyclohexanes or dihydroxycyclopentanes and also mixtures of the aforementioned dihydroxy compounds.

Polycarbonates that are particularly well suited as backing film are those which contain units that are derived from resorcinol esters or alkylresorcinol esters, such as are described, for example, in WO 00/15718 or WO 00/26274; such polycarbonates are marketed, for example, by General Electric Company under the trademark Sollx®.

In addition to these backing films, blends or mixtures of plastics may also be employed. Blends consisting of polycarbonates and polyesters, for example polybutylene terephthalate or polyethylene terephthalate, and polyesters formed from cyclohexanedicarboxylic acid and cyclohexanedimethanol have proved to be particularly advantageous. Such products are marketed under the names Bayfol® by Bayer MaterialScience AG or Xylex® by General Electric Company.

Use may also be made of copolycarbonates according to U.S. Pat. No. 3,737,409; of particular interest in this connection are copolycarbonates on the basis of bisphenol A and di(3,5-dimethyldihydroxyphenyl)sulfone, which are distinguished by a high thermostability. Furthermore, it is possible to employ mixtures of different polycarbonates.

Impact-resistant PMMA is a polymethyl methacrylate that has been given an impact-resistant finish by means of suitable additives, and is preferentially employed. Suitable toughened PMMA are described, for example, by M. Stickler, T. Rhein in Ullmann's Encyclopedia of Industrial Chemistry Vol. A 21, pages 473-486, VCH Publishers Weinheim, 1992, and H. Domininghaus, Die Kunststoffe and ihre Eigenschaften, VDI-Verlag Düsseldorf, 1992.

For the production of the backing film, all known processes, for example by adapter extrusion or co-extrusion or laminating of layers onto one another, enter into consideration. Moreover, the backing film may also be cast from solution.

The surface of the backing film may be glossy, structured or matted.

By way of rear-injection plastics, backing plastics or rear-compression-moulding plastics, all known thermoplastic polymeric materials enter into consideration. Suitable are, for example, thermoplastic polymers such as polyolefins, for example polyethylene or polypropylene, polyesters, for example polybutylene terephthalate (PBT) and polyethylene terephthalate (PET), polycycloolefins, poly(meth)acrylates, polyamides, polycarbonates, polyurethanes, polyacetals, for example polyoxymethylene (POM), polystyrenes, polyphenylene ethers, polysulfones, polyether sulfones, polyether ketones, styrene (co)polymers or mixtures of the aforementioned polymers.

Particularly suitable polycarbonates are bisphenol-A and TMC-bisphenol polycarbonates. Preferred polymer mixtures contain polycarbonate and polybutylene terephthalate or polycarbonate and ABS polymerisate.

By reason of the very good deformation properties and the good adhesion as well as the good stretching behaviour of the coating in the backing film, not only evenly-formed, i.e. substantially flat, or dished mouldings, but also those with indentations and shapings, also perpendicular shapings or depressions, such as, for example, mobile-phone keyboards, can be produced. The good surface properties associated with the backing films are consequently also accessible in the case of composite mouldings with demanding geometry.

The backing films according to the invention are used in telecommunications equipment, in vehicle construction, shipbuilding and aircraft construction.

The present invention also provides the use of the backing film according to the invention for the purpose of finishing plastic mouldings, preferably display-screen housings.

The invention will be elucidated in more detail on the basis of the following Examples.

### EXAMPLES

Unless stated otherwise, all percentage figures are to be understood as percentage by weight.

### Substances and Abbreviations Used:

BYK® 348: wetting agent (BYK-Chemie, Wesel, DE)
BYK® 337: surface additive (BYK-Chemie, Wesel, DE)
MPA: 1-methoxy-2-propyl acetate
Tinuvin® 292 HALS amine (Ciba GmbH, Lampertheim, DE)
Tinuvin® 384-2 UV absorber (Ciba GmbH, Lampertheim, DE)
Bayhydur® VPLS 2306 elasticised, hydrophilic polyisocyanate, (Bayer Material Science AG, DE); mean functionality 2.5.
Bayhydur® XP 2655 hydrophilic polyisocyanate, (Bayer Material Science AG, DE); mean functionality 3.1.

The determination of the solids contents was effected in accordance with DIN-EN ISO 3251.

NCO contents were, unless expressly stated otherwise, determined volumetrically in accordance with DIN-EN ISO 11909.

### Example 1

### Polyester Polyol

Into a 15 l reaction vessel with stirrer, heating apparatus and water separator with cooling apparatus 1281 g phthalic acid anhydride, 5058 g adipic acid, 6387 g hexanediol-1,6 and 675 g neopentyl glycol were weighed and heated up in one hour to 140° C. under nitrogen. In a further 9 hours, heating was effected to 220° C., and condensation was effected at this temperature for such time until an acid value of less than 3 was attained. The polyester polyol obtained in this way had a viscosity (determined as efflux-time of an 80% solution of the polyester in methoxypropyl acetate in a DIN 4 beaker at 23° C.) of 54 seconds and an OH value of 160 mg KOH/g.

### Example 2

### Production of a Polycarbonate Diol on the Basis of 1,4-butanediol and 1,6-hexanediol

1223 g 1,4-butanediol and 535 g 1,6 hexanediol were submitted in a flask and heated up to 100° C. Finally, about 2 l/h nitrogen were introduced into the diol mixture and 20 mbar vacuum was applied and the mixture was dehydrated until such time (about 2 hours) as the water content amounted to <0.1%.

Then 0.44 g ytterbium(III) acetylacetonate were added, the diol mixture was heated up to 110° C. Subsequently in about 20 minutes 2297 g dimethyl carbonate were allowed to flow in, and the reaction mixture was held for 24 h subject to reflux. Finally, the temperature was increased to 150° C., and resulting distillate was removed. Then a further increase was effected to 180° C., followed by a further distillation phase.

The reaction mixture was cooled to 130° C. and the pressure was lowered to 10 mbar. Subsequently a raising of the oil-bath temperature was effected from 130° C. to 180° C. within 2 h, whereby the distillation-head temperature did not exceed 60° C. After reaching 180° C., this temperature was held for 6 h.

Subsequently the reaction mixture was cooled to 130° C. and the pressure was lowered to 10 mbar. Then a raising of the oil-bath temperature was effected from 130° C. to 180° C. within 2 h, whereby the distillation-head temperature did not exceed 60° C. After reaching 180° C., this temperature was held for 6 h. The reaction mixture was cooled to room temperature, and the characteristic data of the product were determined.

A polycarbonate diol with a hydroxyl value of 57.3 mg KOH/g and also with a viscosity of 115 Pas at 23° C. was obtained.

### Example 3

### Production of a Polycarbonate Diol on the Basis of 1,4-butanediol and 1,6-hexanediol

1239 g 1,4-butanediol and 542 g 1,6 hexanediol were submitted in a flask and heated up to 100° C. in an oil bath. Finally, about 21/h nitrogen were introduced into the diol mixture, and 20 mbar vacuum was applied, and the mixture was dehydrated until such time (about 2 hours) as the water content amounted to <0.1%.

Then 0.44 g ytterbium(III) acetylacetonate were added and the diol mixture was heated up to 110° C. Subsequently, in about 20 minutes 2180 g dimethyl carbonate were allowed to flow in, and the reaction mixture was held for 24 h, subject to reflux. Finally, the temperature was increased to 150° C., and resulting distillate was removed. Then a further increase was effected to 180° C., followed by a further distillation phase.

The reaction mixture was cooled to 130° C. and the pressure was lowered to 10 mbar. Subsequently a raising of the oil-bath temperature was effected from 130° C. to 180° C. within 2 h, whereby the distillation-head temperature did not exceed 60° C. After reaching 180° C., this temperature was held for 6 h.

Subsequently the reaction mixture was cooled to 130° C. and the pressure was lowered to 10 mbar. Then a raising of the oil-bath temperature was effected from 130° C. to 180° C. within 2 h, whereby the distillation-head temperature did not exceed 60° C. After reaching 180° C., this temperature was held for 6 h. Then the reaction mixture was cooled to room temperature and the characteristic data of the product were determined.

A polycarbonate diol with a hydroxyl value of 113.4 mg KOH/g and also with a viscosity of 13,600 mPas at 23° C. was obtained.

### Example 4

### Hydroxy-Functional PUR Dispersion

In a 6 l reaction vessel with cooling, heating and stirring apparatus 1170 g of the polyester polyol from Example 1 were submitted in a nitrogen atmosphere and together with 1140 g polycarbonate diol from Example 2, 90 g trimethylolpropane, 120 g dimethylolpropionic acid and 3.8 g tin(II) octoate were heated up to 130° C. and homogenised for 30 min. Subsequently cooling was effected to 80° C., 480 g hexamethylene diisocyanate were added with vigorous stirring, heating was effected to 140° C., utilising the exothermic reaction, and the mixture was held at this temperature until such time as no more NCO groups could be detected.

Subsequently the polyurethane obtained in this way was cooled to 90° C.-100° C., 47 g dimethylethanolamine (degree of neutralisation 60%) were added, homogenisation was effected for 15 minutes, and the mixture was dispersed with 2270 g demineralised water. The aqueous polyurethane-resin dispersion obtained in this way had an OH content (100%) of 1.4%, an acid value (100%) of 16.8, a mean particle size of 110 nm and a viscosity of about 2020 mPas (23° C.; D=40 s⁻¹) with a solids content of 51.2 wt. %.

### Example 5

### Hydroxy-Functional PUR Dispersion

In a 6 l reaction vessel with cooling, heating and stirring apparatus 1170 g of the polyester polyol from Example 1 were submitted in a nitrogen atmosphere and together with 1140 g polycarbonate diol from Example 3, 90 g trimethylolpropane, 120 g dimethylolpropionic acid, 125 g N-methylpyrrolidone and 3.8 g tin(II) octoate were heated up to 130° C. and homogenised for 30 min. Subsequently cooling was effected to 80° C., 480 g hexamethylene diisocyanate were added with vigorous stirring, heating was effected to 140° C., utilising the exothermic reaction, and the mixture was held at this temperature until such time as no more NCO groups could be detected.

Subsequently the polyurethane obtained in this way was cooled to 90° C.-100° C., 39 g dimethylethanolamine were added (degree of neutralisation 50%), homogenisation was effected for 15 minutes, and the mixture was dispersed with 2270 g demineralised water. The aqueous polyurethane-resin dispersion obtained in this way had an OH content (100%) of 1.4%, an acid value (100%) of 16.3, a mean particle size of 150 nm and a viscosity of about 1680 mPas (23° C.; D=40 s⁻¹) with a solids content of 55.9 wt. %.

### Example 6

### Scratch-Resistant Clear Lacquer (Reference Example)

### Preparation of the Base (Component A)

To 56.80 g of the polyurethane dispersion from Example 50.45 g Byk® 347, 0.77 g Byk® 337 and 22.17 g distilled water were added and intimately stirred.

### Preparation of the Curing-Agent Solution (Component B)

To 8.60 g Bayhydur® XP 2655 0.77 g Tinuvin® 292 (50% solution in MPA), 1.16 g Tinuvin® 384-2 (50% solution in MPA) and also 9.28 g MPA were added and intimately stirred.

### Example 7

### Scratch-Resistant Clear Lacquer

### Preparation of the Base (Component A)

To 51.59 g of the polyurethane dispersion from Example 50.45 g Byk® 347, 0.77 g Byk® 337 and 24.59 g distilled water were added and intimately stirred.

### Preparation of the Curing-Agent Solution (Component B)

To 11.34 g of a mixture of Bayhydur® Bayhydur® XP 2655/Bayhydur® VP LS 2306 (in each case 50 wt. %) 0.77 g Tinuvin® 292 (50% solution in MPA), 1.16 g Tinuvin® 384-2 (50% solution in MPA) and also 9.33 g 1-methoxypropyl acetate (MPA) were added and intimately stirred.

### Example 8

### Reference

Unlacquered polycarbonate film (film thickness: 175 μm)

Mixing of the Base with the Curing Agent and Application

Components A (base) and B (curing agent) listed above were in each instance mixed together and intimately stirred (Dispermat, 2 min at 1000 rpm). Subsequently the mixtures were applied by doctor blade onto polycarbonate film (175 μm), exposed to the air for 5 min at room temperature and subsequently dried for 45 min at 80° C. in a circulating-air oven. High-gloss films with a dry-film layer thickness of about 15 μm were obtained. An overview of the ascertained lacquer properties of the films is presented in the Table.

### Lacquer Properties:

TABLE 1

| | Example | | |
|---|---|---|---|
| | | | 8 |
| | | 7 | (unlacquered |
| | 6 | (according to | PC film, |
| | (reference) | the invention) | reference) |
| Adhesion | Gt0 | Gt0 | — |
| Scratch resistance | 1 | 0 | 5 |
| Resistance to chemicals | | | |
| Isopropanol | 0 | 0 | 0 |
| Rapeseed oil | 0 | 0 | 3 |
| Nivea hand cream | 0 | 0 | 0 |

### Test Methods:

Adhesion: According to DIN EN ISO 2409

### Scratch Resistance:

The scratch resistance was carried out with a Crockmeter Atlas CM6. The surface of the film was scratched with an abrasive paper (9 μm, 10 or 40 double strokes). Assessment of the scratched film surface was effected in accordance with DIN 53230:

0: no scratches discernible
1: isolated scratches discernible
2: scratches discernible
3: distinct scratches discernible
4: many scratches discernible
5: very many scratches discernible

### Resistance to Chemicals:

Test with isopropanol, rapeseed oil, Nivea hand cream.

Loading-time 24 h at room temperature. The assessment of the loaded film surface was effected in accordance with DIN 53230.

DIN 53230 specifies a relative evaluation scale for visual comparison:

TABLE 2

| Index | Significance | Explanatory remarks |
|---|---|---|
| 0 | not changed | |
| 1 | trace changed | swelling ring is very weak, only to be |
| | | discerned by reflecting in the light |
| | | swelling ring is clearly interrupted |
| 2 | slightly changed | swelling ring is discernible in the light |
| | | scratch marks discernible |
| 3 | medium changed | closed swelling ring is clearly discernible |
| | | slightly scratchable |
| 4 | greatly changed | closed swelling ring is very strongly |
| | | pronounced |
| | | scratchable |
| 5 | very greatly changed | capable of being scratched through |

### Thermoformability by Means of High-Pressure Deformation

The Makrofol® DE 1-1 films (Bayer MaterialScience AG, DE) coated in accordance with Examples 6 and 7 were deformed in accordance with DE-A 38 40 542. The experiments were carried out in a high-pressure deformation unit manufactured by HDVF Kunststoffmaschinen GmbH, type SAMK 360. A mobile-phone-shell tool was used as deformation tool. The deformation parameters were chosen as follows: heating-rate: 14 sec, heating-field setting 240° C.—280° C., tool temperature 80° C., deformation pressure 80 bar. In the deformed films the adhesion, the cracking, and also the coating after the deformation were assessed.

Test Results of the Makrofol® De 1-1 Films Coated with Lacquers 6 and 7.

TABLE 3

| | Cracking at 14 sec |
|---|---|
| | heating-rate |
| | (tool: mobile- |
| Example | phone shell) |
| 6 | cracking, edge |
| 7 | flawless |

The listed results provide evidence that only with the lacquers formulated in accordance with the invention can very good thermoformability of the coated film be obtained.

1. Aqueous two-component polyurethane lacquer comprising
A) at least one hydroxy-functional polyester-polyurethane dispersion comprising as structural components
a1) linear or branched, hydroxy-functional polyesters,
a2) linear, hydroxy-functional polycarbonates,
a3) at least one ionic or potentially ionic compound with at least one acid group and with at least one group that is reactive towards isocyanate groups,
a4) at least one (cyclo)aliphatic diisocyanate and also
a5) low-molecular hydroxy-functional and/or amino-functional compounds,
and also
B) at least one polyisocyanate cross-linker, wherein the cross-linking ratio of isocyanate groups from B) to hydroxy groups from A) is from 1.0:1 to 1.6:1.

2. Aqueous two-component polyurethane lacquer according to claim 1, wherein the cross-linking ratio of isocyanate groups from B) to hydroxy groups from A) is from 1.2:1 to 1.4:1.

3. Aqueous two-component polyurethane lacquer according to claim 1, wherein the mean functionality of the polyisocyanates B) amounts to 2.5 to 3.3.

4. Aqueous two-component polyurethane lacquer according to claim 1, wherein the polyester-polyurethane dispersion A) comprises 20 wt. % to 50 wt. % component a1), 20 wt. % to 50 wt. % component a2), 2 wt. % to 6 wt. % component a3), 10 wt. % to 30 wt. % component a4), 0.5 wt. % to 10 wt. % component a5), whereby the percentage figures a1) to a5) make up 100 wt. %.

5. Aqueous two-component polyurethane lacquer according to claim 1, wherein the acid values, incorporated via component a3), of the hydroxy-functional polyester-polyurethane dispersion A) amount to 5.0 to 14.5 mg KOH/g substance, in each instance relative to the aqueous dispersion of the polyester polyurethane.

6. Aqueous two-component polyurethane lacquer according to claim 1, wherein the mean molecular weight M_{w} of the polyester-polyurethane dispersion A), determinable by gel permeation chromatography with polystyrene as standard, amounts to 5000 g/mol to 15,000 g/mol.

7. Aqueous two-component polyurethane lacquer according to claim 1, wherein polyesters a1) are reaction products of
a1ᵢ) 30 wt. % to 77 wt. % of at least one at least difunctional carboxylic acid or anhydride thereof,
a1ᵢᵢ) 23 wt. % to 70 wt. % of at least one diol,
a1ᵢᵢᵢ) 0 wt. % to 10 wt. % of at least one alcohol with more than 2 hydroxyl groups,
a1ᵢᵥ) 0 wt. % to 10 wt. % of other hydroxy-functional and/or carboxy-functional components and/or caprolactone.

8. Aqueous two-component polyurethane lacquer according to claim 1, wherein polycarbonate polyols a2) are those which contain at least 25 wt. % 1,4-butanediol as structural component and exhibit a mean hydroxyl functionality from 1.6 to 4 and a number-average molecular weight from 240 g/mol to 8000 g/mol.

9. An aqueous two-component polyurethane lacquer according to claim 1 suitable for producing coated backing films.
